(19) United States
(12) Patent Application Publication
(10) Pub. No.: US 2025/0135639 A1
(43) Pub. Date: May 1, 2025

(54) CONTEXT-AWARE SIMILARITY FOR TRAJECTORY FORECASTING AND MONITORING

(71) Applicant: Dell Products L.P., Round Rock, TX (US)

(72) Inventors: Vinicius Michel Gottin, Rio de Janeiro – RJ (BR); Pablo Nascimento da Silva, Niterói – RJ (BR); Paulo Abelha Ferreira, Rio de Janeiro – RJ (BR)

(21) Appl. No.: 18/497,811

(22) Filed: Oct. 30, 2023

(51) Int. Cl. B25J 9/16

(52) U.S. Cl. CPC B25J 9/1664

(57) ABSTRACT

Context aware trajectory forecasting is disclosed. A mobile entity operating in an environment may be performing a task or be associated with a context. The task or context of the mobile entity is determined and filtered with respect to a structure that stores context or task-based typical or rich trajectories. Candidate trajectories are identified and similarity scores are determined for the candidate trajectories. The similarity scores account for attribute importances. This allows a trajectory of the mobile device to be forecast with respect to the historical data of other mobile devices performing the same or similar tasks or that have a similar context.

### RELATED APPLICATIONS

This application is related to U.S. Ser. No. 18/160,601 filed Jan. 27, 2023 and entitled WEIGHTED TRAJECTORY SIMILARITY DETERMINATION BASED ON SUB-TRAJECTORY QUERYING, and to U.S. Ser. No. 17/585,055 filed Jan. 26, 2022 and entitled EDGE-ENABLED TRAJECTORY MAP GENERATION, which applications are incorporated herein by reference in their entirety.

### FIELD OF THE INVENTION

Embodiments of the present invention generally relate to logistics systems and logistics operations. More particularly, at least some embodiments of the invention relate to systems, hardware, software, computer-readable media, and methods for performing logistics operations including context-aware trajectory forecasting and trajectory monitoring.

### BACKGROUND

In many environments or domains, such as warehouses, there is a need to manage logistics of the devices operating in the domain. More specifically, many types of devices (e.g., machines or other objects) operate in these environments. Some of the devices may be controlled by a user/driver while other devices may be autonomous. When devices such as forklifts and autonomous mobile robots are operating in these environments, there is a need to perform logistics operations, which may include decision making operations. These decisions are often made in the context of logistics operations such as warehouse management and safety operations.

The devices often include sensors, such as position sensors. By tracking the positions of the devices, actions may be performed based on the position data. More specifically, these sensors may provide data that allows a device's position, speed, orientation, and trajectory to be monitored/determine in real time or nearly real time. Logistics operations and decisions based on the device's most recent positions in this context, however, may still lag behind real-time conditions. Logistics operations could be improved if various characteristics of these devices, such trajectory, can be anticipated. This would allow decisions and actions to be made more efficiently and more quickly.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of collecting data, including context data, from devices or nodes operating in a domain;

FIG. 2 discloses aspects of rich trajectories;

FIG. 3A discloses aspects of rich trajectories and task-bound rich trajectories;

FIG. 3B discloses aspects of relationships between sub-trajectories and a rich trajectory;

FIG. 3C discloses aspects of a method for generating task-bound rich trajectories;

FIG. 3D discloses additional aspects of generating task-bound rich trajectories;

FIG. 3E discloses additional aspects of generating task-bound rich trajectories;

FIGS. 4A, 4B, 4C, 4D, 4E and 4F disclose aspects of associating tasks to rich trajectories or to nodes of rich trajectories;

FIG. 5 discloses aspects of determining feature or attribute importance for task-bound rich trajectories;

FIG. 6A discloses aspects of data collected from a mobile device or other entity;

FIG. 6B discloses aspects of identifying similar trajectories based on path;

FIG. 6C discloses aspects of determining a similarity score between a current trajectory and candidate trajectories;

FIG. 7 discloses aspects of determining a context aware trajectory that is most similar to a current trajectory;

FIG. 8 discloses aspects of a computing device, a computing system, or a computing entity.

### DETAILED DESCRIPTION OF SOME EXAMPLE EMBODIMENTS

Embodiments of the present invention generally relate to logistics, logistics operations, and trajectories including context-aware trajectories. More particularly, at least some embodiments of the invention relate to systems, hardware, software, computer-readable media, and methods for determining trajectories of devices operating in an environment using contextual information and context-aware forecasting trajectories of devices operating in the environment.

Conventionally, the ability to access historical trajectories to determine a likely current trajectory of a device may lead to inconsistent results. For example, in certain situations, the projected trajectory may alternate between different trajectories that are considered to be distinct. Further, a likely trajectory may be influenced by context. For example, the trajectories of two mobile devices (e.g., forklift, an autonomous mobile robot) of the same type may be considered to be similar in path and have similar attributes if they are both carrying a load. The trajectories may be considered difference if one of the mobile devices is loaded and the other is not loaded.

For example, two distinct trajectories may have a common straight portion. At an upcoming position, one of the trajectories forecasts a left turn while the other trajectory forecasts a right turn. Changes in the device's current position and current path or trajectory may cause a decision engine to forecast or expect the first trajectory and then, a short time later, forecast or expect the second trajectory. This type of uncertainty can complicate a decision making process as a first action or decision may be determined and performed if the device turns left and a second action or decision different from the first action may be determined and performed if the device turns right. The inability to more accurately determine or predict the current expected trajectory may impact the actual operation of the device and may lead, by way of example, to an unsafe outcome.

Embodiments of the invention relate to querying a trajectory database to determine an expected or anticipated trajectory of a device. By identifying a similar trajectory, the path or trajectory of the device can be forecast. In one example, historical trajectories for multiple devices may be used to generate the trajectory database. Many of these trajectories may share common portions or may overlap with each other. The historical trajectories may be processed to generate typical device trajectories. The typical trajectories are converted to rich typical trajectories (also referred to as typical trajectories or rich trajectories) by associating them with attribute data, such as sensor data. When querying the database, the query can identify candidate trajectories, determine a similarity score for each of the candidate trajectories, and return a final trajectory that has the best similarity score. When generating the similarity score, aspects of the trajectories and/or their attributes can be weighted. For example, older positions may have less weight than more current positions in time.

Embodiments of the invention relate to querying a trajectory database to robustly determine a typical current trajectory that is likely to be the trajectory followed by the device. This approach uses a short-term history of positioning and sensor data from the device to determine the device's likely trajectory from a set or database of known typical trajectories. Embodiments of the invention further leverage device attributes that may be derived from sensor data to determine the likely trajectory of the device. This allows the process of forecasting a likely trajectory to be aware of context in addition to simply position. When selecting or choosing from multiple candidate trajectories, embodiments of the invention allow the trajectories to be weighted using, in some examples, the device's attributes or characteristics.

Embodiments of the invention thus relate to systems and methods for performing queries for robustly determining or forecasting a typical trajectory, which may correspond to the device's actual or anticipated trajectory. Embodiments of the invention provide a mechanism that allows a weighted similarity of previous points in the current path of the device to be compared with points in the trajectories being queried. The selection or identification of a typical trajectory that is similar to the current trajectory of the device may use a similarity score that reflects the similarity in position and/or similarity in attributes.

Embodiments of the invention further relate to using operational logs to determine or identify tasks being performed by the device in the context of determining a current trajectory. Embodiments of the invention may relate to a database of trajectories that are related to or that account for tasks or other context. This allows a search for a similar trajectory to be conditioned to the context, such as a specific task. Advantageously, the weights to be given to various attributes, for determining trajectory similarity, can be learned from historical data. Advantageously, human intervention and supervision can be avoided.

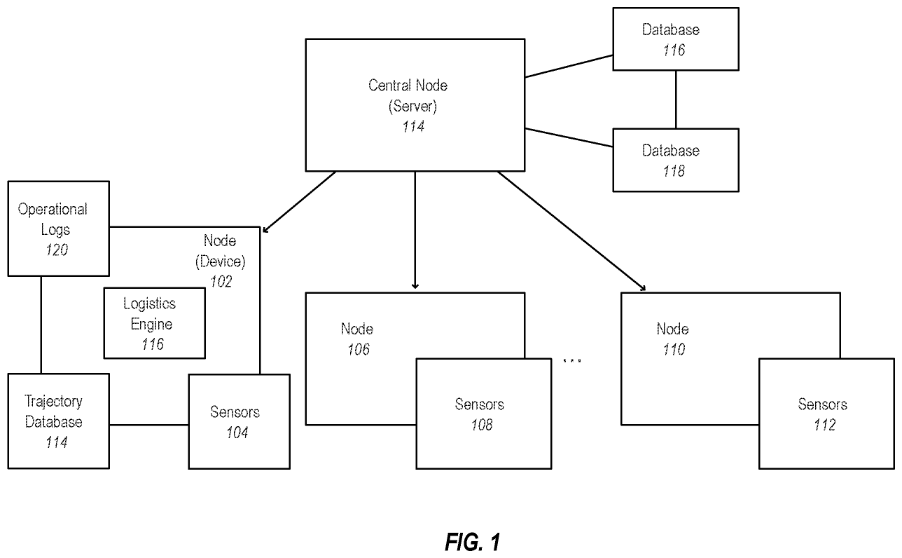

Embodiments of the invention thus relate to identifying or determining likely current trajectories based in part on a device's current task, which may be extracted from operational logs. Embodiments of the invention may further relate to determining the appropriate weights to be given to attributes typical trajectories, which may be used in determining trajectory similarity. In sum, embodiments of the invention relate to context-based trajectory forecasting. FIG. 1 discloses aspects of collecting data from devices (referred to herein as nodes) operating in an environment or domain. Examples of nodes include forklifts, autonomous mobile robots, or the like. As used herein, nodes may refer to the devices themselves and/or to computing resources associated with or included in the node. For example, a node such as an autonomous mobile robot may include processors, memory, networking hardware, and the like. The node may be configured with sensors such as position sensors, inertial sensors, direction sensors, and the like. The collection of sensors associated with a node may depend on the node. A forklift, for example, may include sensors related to mast height, mast position, load weight, and the like.

Data collected from a node's sensors can be correlated. Further, the collection of data from the sensors may be performed on command, periodically, and/or in response to an event. For example, detecting acceleration/deceleration may cause data to be collected.

FIG. 1 discloses aspects of a domain in which nodes operate. An example domain is a warehouse or other environment. FIG. 1 illustrates nodes 102, 106, and 110, which are associated with, respectively, sensors 104, 108, and 112. Data collected from the sensors 104, 108, and 112 may be transmitted to a central node 114 and stored in a database 116. The data stored in the database 116 include trajectory data, sensor data, position data, or the like or combinations thereof.

Trajectory data may correspond to collections of position data. For example, multiple positions, each associated with a different timestamp, may define a path or a trajectory. The data stored in the database 116 may be used to train machine learning models, generate inferences from machine learning models or the like. The nodes 102, 106, and 110 may also include models that may generate inferences using locally generated and/or collected data. The inferences generated by the models may be used in decision making operations by the central node 114 and/or at the nodes 102, 106, and 110.

In this example, a model such as a logistics engine 116 is illustrated. Other nodes may be similarly configured. In this example, the logistics engine 116 is configured to query the trajectory database 114. Querying the trajectory database 114 is performed to determine the most likely trajectory of the node 102 or to forecast the likely trajectory of the node 102. The query may include data obtained from the sensors 104. For example, a current or most recent position of the device may be used to identify candidate trajectories from the trajectory database. The candidate trajectories may then be processed to identify a final trajectory that may be used by the logistic engine 116 to generate inference or perform other logistics operations. The inference may be used in decision making operations. The final trajectory, which is most similar to the device's current trajectory, may be determined to be a forecasted trajectory.

The nodes in a domain, represented by the nodes 102, 106, and 110, are an example of a set of nodes or entities ( [symbol] ). For each node Eᵢ ∈ [symbol] , sequences of collections of data are obtained. Each collection may correspond to a position of the node, sensor data or other attributes at a particular point in time represented by a timestamp.

If it is necessary to determine a distance between any two positions (of the same node or of different nodes) a distance function can determine a distance between any two positions. The distance may be a Euclidean distance, determined from GPS coordinates, RFID based, or the like. The manner in which distance is determined may depend on how the position is determined. In some examples, the position of a node may be determined using sensors that are external to the node.

In one example, each of the nodes 102, 106, and 110 may also be associated with operational logs, represented as the operational logs 120, or other contextual data. The operational logs 120 of the node 102 may allow the current task (and/or historical tasks) of the node 102 to be determined. Embodiments of the invention further incorporate contextual data when determining or forecasting a device's trajectory. Thus, the anticipated trajectory of the node 102 may be based on, in addition to positional information and other attributes, context information included in the logs 120.

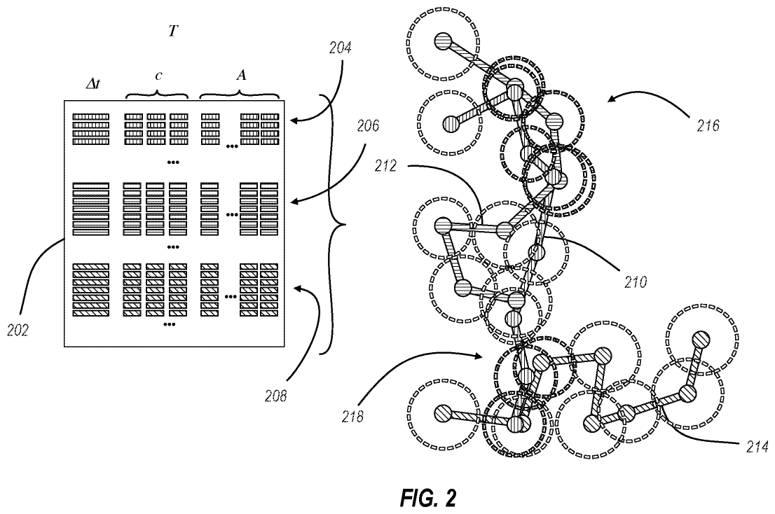

FIG. 2 discloses aspects of rich typical trajectories. The rich trajectory database 202 (T) is based on historical data or historical trajectories from multiple nodes. A typical or rich trajectory, for example, may be based on a set of trajectories determined from sensor data. A node, such as the node 102, may include a logistic engine 116 (or other engine) that may query the rich trajectory database 202 to determine a most likely current trajectory of the node 102 based on a current position of the node 102 and/or a current task of a node, previous positions of the node, current readings from the node's sensors (and/or other sensors) and/or previous readings of the sensors. More specifically, the trajectory database 202 of rich trajectories allows the logistics engine 116 to forecast or determine an expected trajectory based on a one or more recent positions of the node.

FIG. 2 also discloses aspects of rich typical trajectories. The rich trajectories 210, 212, and 214 represent rich typical trajectories and illustrates that these trajectories have overlapping positions. In one example, a rich typical trajectory is derived from multiple sub-trajectories.

FIG. 2 illustrates a rich typical trajectory database 202 that includes, by way of example, trajectories 210, 212, and 214. The trajectories 210, 212, and 214 are associated with, respectively, collections 204, 206, and 208 in the database 202. The collections 204, for example, define the nodes of the typical rich trajectory 210.

As further illustrated in FIG. 2, the rich typical trajectories 210, 212, and 214 have overlapping portions 216 and 218. Because of the overlapping portions 216 and 218, it is often difficult to determine which of the typical trajectories represented in the overlapping portions is most similar to a current trajectory of the device. Embodiments of the invention thus relate to querying the database 202 in order to identify the typical trajectory that is most similar to the node's current trajectory and is considered to be the device's expected trajectory.

Embodiments of the invention further relate to performing the query using a current task of a node (device). More specifically, embodiments of the invention generate context-aware typical or rich trajectories. When considering the trajectories 210, 212, and 214, the one associated with a task that is the same as or quite similar to a current task will be selected as the most similar rich trajectory. The rich trajectories associated from different tasks may, in example, be excluded from consideration. However, this information may be retained such that the behavior of trajectory selection and identification can be monitored and corrected or rectified if necessary.

In one example, rich trajectories may be defined not only with respect to path similarity but also to a weighted attributed importance similarity (e.g., task or other attributes).

In one example, a machine learning model is configured to generate an inference as to a likely current trajectory. In some examples, determining the importance of features plays a role in explainability, active acquisition and feature selection, engineering, and extraction. For example, model weights or operations may be used to gauge the feature importance during training. Statistical tools (e.g., variation of data according to specific circumstances, may be used to relate inputs or features with outputs of trained models.

Embodiments of the invention thus relate to rich trajectories that consider contextual information and allow the weights to be given to attributes used in determining similarity between rich trajectories to be determined automatically. Context information may be obtained from operational logs or other sources of information such as control and monitoring systems, historical data (e.g., load schedules, package manifest), or the like. In one example, the domain-relevant tasks are associated with timestamps for start and end (or start and duration.

In order to enable context-aware querying of likely trajectories for a mobile entity or device operating in a domain, various operations may be performed. First, tasks may be associated to typical trajectories in the database 202. This may result in a structure [symbol] pf task-bound typical trajectories. Second, the importance of attributes for computing the trajectory similarity is determined. This information enables context-aware querying.

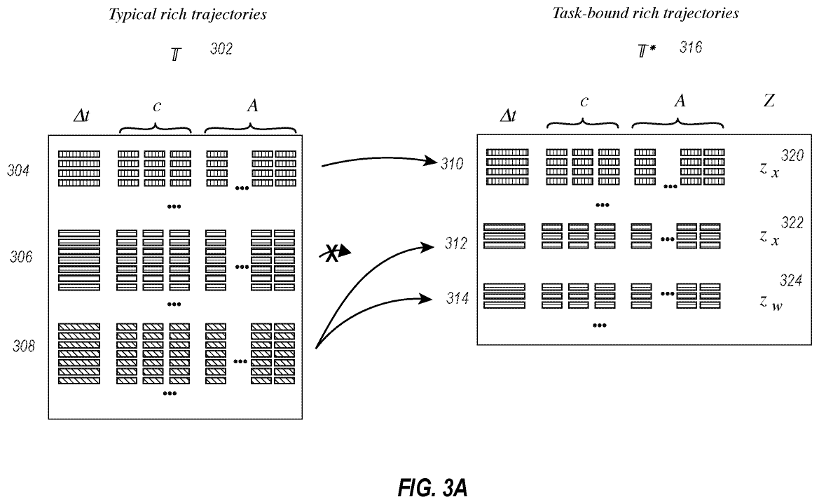

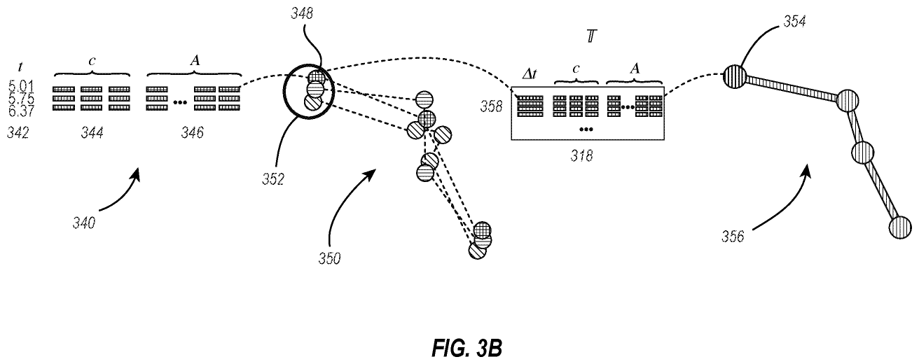

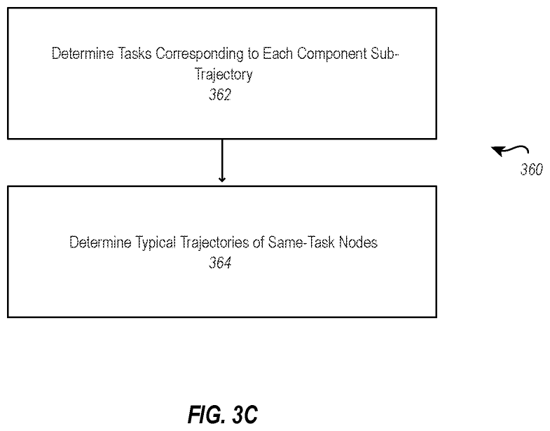

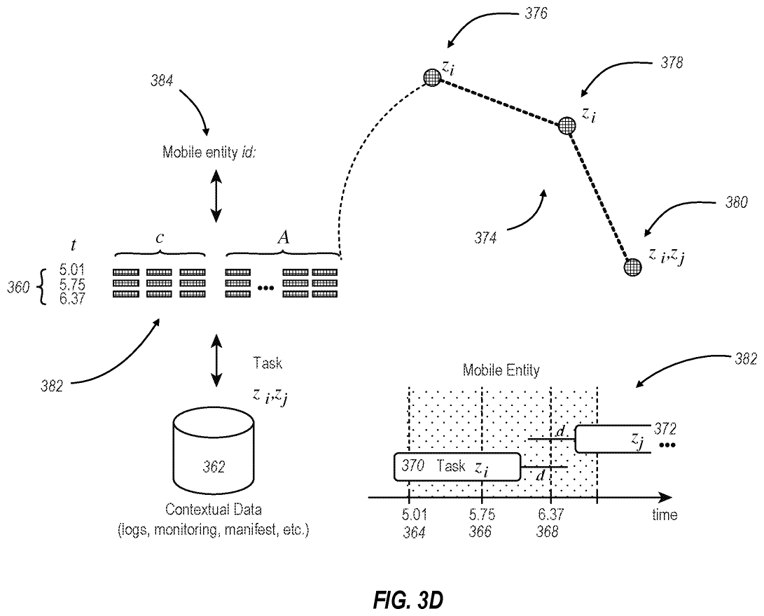

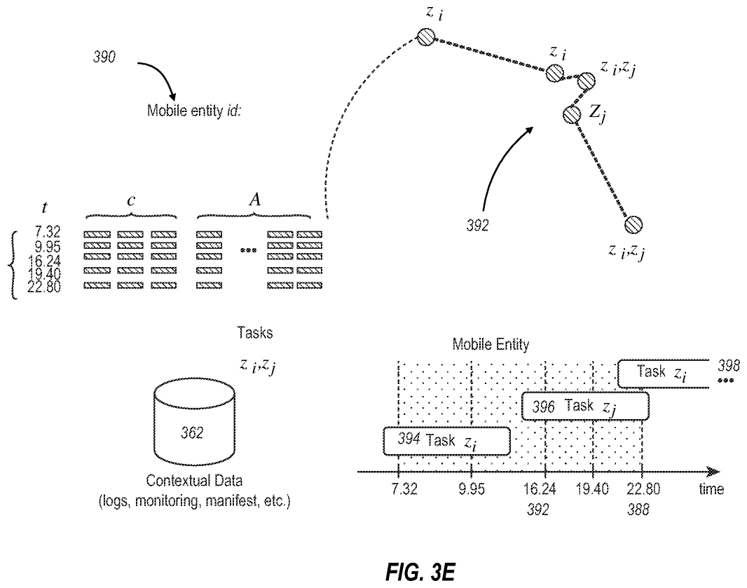

FIG. 3A discloses aspects of rich trajectories and of task-bound rich trajectories. FIG. 3A discloses aspects of determining a task Z for each rich trajectory. This example illustrates the process of assigning or associating tasks to specific trajectories. The rich trajectories 302 ( [symbol] ) include or are defined by collections of data that may include positional data. Thus, the typical rich trajectories includes collections 304, 306, and 308. The collections may include a series of collected data and each series may correspond to a node of the rich trajectory. In the process of generating the task-bound rich trajectories ( [symbol] ) 316, some of the rich trajectories, such as the trajectory 306, may be discarded. The rich trajectory 308, in this example, is split into two task-bound rich trajectories 312 and 314.

The process of associating tasks to rich trajectories, in FIG. 3A, shows that the task-bound rich trajectories 310, 312, and 314, are associated with, respectively, tasks 320, 322, and 324 (zₓ, zₓ, z_{w}) in this example.

FIG. 3B discloses aspects of relationships between sub-trajectories and a typical or rich trajectory. More specifically, FIG. 3B discloses aspects of generating rich trajectories. In this example, the rich trajectory 356 is assembled from collections 340 of data from one or more mobile devices. The collections 340 may include or be used to determine specific sub-trajectories of specific devices.

The collections 340, more specifically, represents a set of data collected from one or more devices at various points in time. Each instance (or collection) in the collections 340 may correspond to a specific device at a specific time. The collections 340 of data from mobile devices may include timestamps 342, position coordinates (or data) 344, and sensor attributes 346 or sensor data.

The node point 348 corresponds to a first row of data in the collections 340 for a specific device. The trajectories 350 graphically illustrate three different sub-trajectories of three devices in this example and the points of the sub-trajectories representing positions of the devices in each individual trajectory are connected by dotted lines. The timestamps and attributes (e.g., sensor data) may be associated to each point in the representation 350.

The rich trajectory 356 is generated from the trajectories 350. Nodes that are within a specified distance of each other may be used to generate a particular node of the rich trajectory. Further the node 354, in the rich trajectory 356, is associated with a first row in the rich trajectories 318 (e.g., a database). Each row in the rich collections 318 represents a node in the rich trajectory 356 and includes a timestamp since a previous node (Δt), an aggregate of the position coordinates (c) and an aggregate of attributes or sensor data from the sub-trajectories 350 or represented in the collection 340. Thus, the trajectory 358, which corresponds to multiple rows in the database 318, is graphically represented as the trajectory 356. Each node in the trajectory 356 corresponds to a row in the collections 358.

More specifically, the node points in the circle 352 each correspond to a row in the collections 340. The collections 340 does not represent all of the node points in the trajectories 350. The node points (and the corresponding data in the collections 342) in the circle 352 are used to generate the first row in the collections 318, which corresponds to the node 354 in the trajectory 356. Thus, the first row in the collections 318 includes an aggregate of the position coordinates and an aggregate of the attributes or sensor data. A timestamp representing the individual timestamps (e.g., Δt) is also included in the collections 318. Thus, a rich trajectory 356 may be generated or determined from sub-trajectories 350.

FIG. 3C discloses aspects of a method for generating task-bound rich trajectories. The method 360 generally include determining 362 tasks corresponding to each rich trajectory or to each node of each rich trajectory. This may include determining tasks associated with the sub-trajectories used to generate the rich trajectories. Once tasks are assigned to or associated with the rich trajectories (and/or the sub-trajectories), task-bound rich trajectories can be determined 364 and stored in a database.

More specifically, for each of the sub-trajectory conforming to the rich trajectory, a reference or other identifier of the mobile device performing the trajectory is determined. Next, using the timestamps, the start and end times associated with the nodes of the sub-trajectories are determined. Then, contextual information that is available and performed by that mobile entity are identified (e.g., tasks zᵢ, z, . . . ). These contextual data are associated to typical trajectory nodes as appropriate.

FIG. 3D discloses additional aspects of generating task-bound rich trajectories. FIG. 3D illustrates a process for associating tasks to points in a sub-trajectory with a time allowance of d. FIG. 3D illustrates collections 382 of data (e.g., each row is an individual collection with a timestamp) associated with timestamps 360 that include timestamps 364, 366, and 368. The sub-trajectory 374 may correspond to the collections 382 of data. Each node of the sub-trajectory 374 may correspond to one of the collections 382.

In this example, the mobile entity identifier 384 is obtained for the mobile entity performing the sub-trajectory 374 represented by the collection 382.

Using the timestamps 360, the start and end times of the sub-trajectory 374 may be determined. Next, available contextual data, such as tasks, occurring in the time period are identified as illustrated at 382. In this example, the task 370 (zᵢ) is associated to the timestamps 364 and 366. The task 370 is also associated to the nodes 376 and 378 in the trajectory 374.

In this example, a point or node in a sub-trajectory, such as the node 380 associated with the timestamp 368, may not correspond to any task currently being executed. In this example, the task 370 could be extended and associated with the timestamp 368 if all other points in the sub-trajectory relate to the same task 370. However, if all of the points in the sub-trajectory do not relate to the same task, the timestamp 368 or node 380 may not be associated with a task. Alternatively, one or more tasks may be assigned to any point not assigned to a task.

FIG. 3E discloses additional aspects of generating task-bound rich trajectories. FIG. 3E is similar to FIG. 3D, but for a different mobile entity 390. FIG. 3E illustrated three tasks 394, 396, and 398. The tasks 394 and 398 are the same task or different instances of the same task. FIG. 3E illustrates that, for the mobile entity 390, the tasks 394 and 396 overlap at the timestamp 392. The tasks 396 and 398 overlap at the timestamp 388. This is reflected in the trajectory 392, where some of the nodes in the trajectory 392 are associated with multiple tasks (e.g., zᵢ, and zⱼ).

As illustrated in FIGS. 3A-3E, typical rich trajectories can be analyzed and associated with tasks that may be retrieved from contextual data, such as the contextual data 362. Further, the tasks, in addition to being associated with a trajectory, are also associated with specific mobile entities.

Once tasks have been associated to or with sub-trajectories and/or with the rich trajectories, embodiments of the invention may split the rich trajectories based on the associated tasks to generate task-bound rich trajectories. Embodiments of the invention may initially determine whether a rich trajectory needs to be split. For each node or node point in a rich trajectory, the associated tasks associated to the node points of the sub-trajectories are considered. If all node points corresponding to a node of the rich trajectory are associated to the same task z, then that node of the rich trajectory is also considered to be associated to the same task.

As discussed above, each node of a rich trajectory may be derived from the node points of multiple sub-trajectories as illustrated in FIG. 3B, where multiple node points from multiple sub-trajectories correspond to the node 354 of the rich trajectory 356.

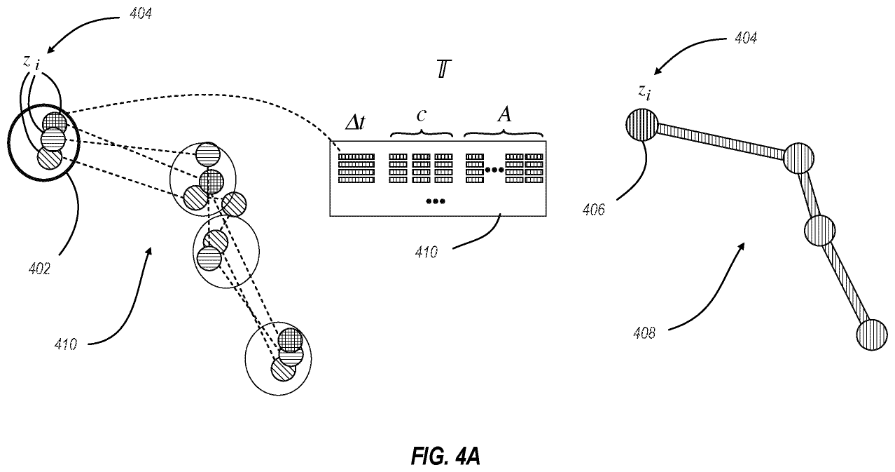

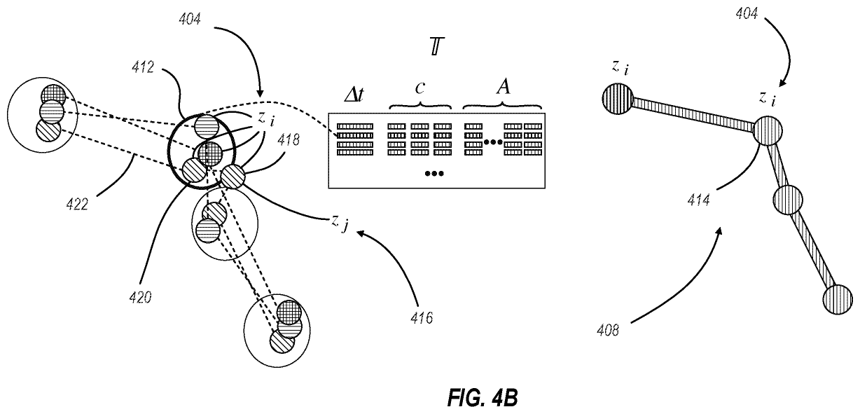

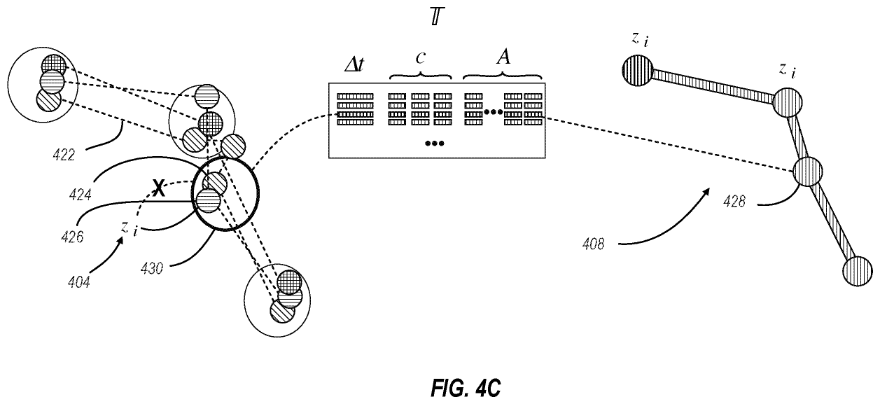

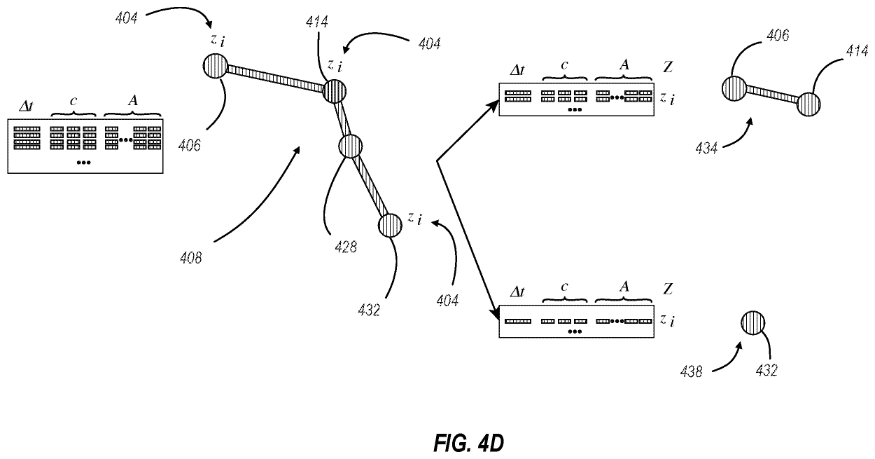

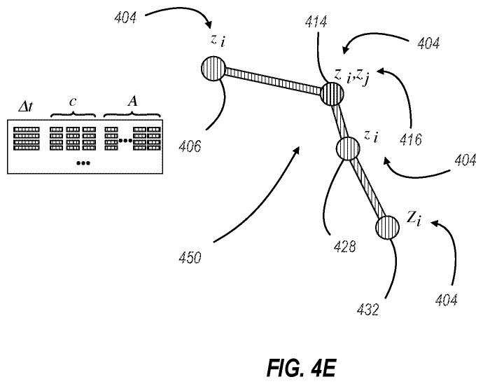

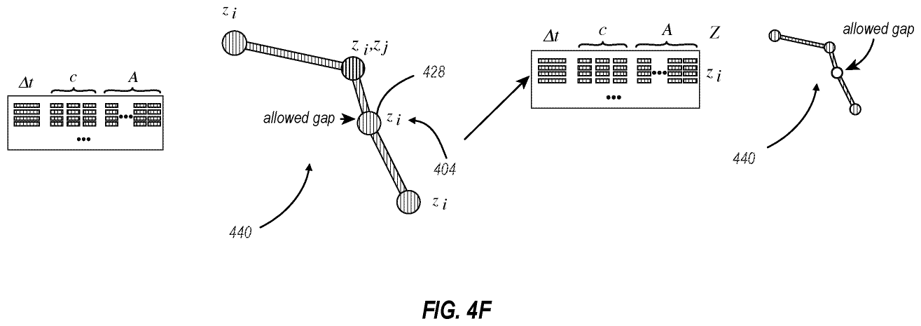

FIGS. 4A, 4B, 4C, 4D, and 4E disclose aspects of associating tasks to rich trajectories or to nodes of rich trajectories.

FIGS. 4A, 4B, and 4C show an example of consecutive steps and FIGS. 4D and 4E illustrates a final results after processing the trajectory 408 for two tasks. FIG. 4A illustrates a rich trajectory 408 generated from sub-trajectories 410. The node points 402 that are associated with the node 406 or that are used to generate the node 406 are associated with different sub-trajectories. Each of the node points 402 are associated with the same task 404 (zᵢ) in this example. As a result, the task 404 is assigned to the node 406 of the rich trajectory 406.

FIG. 4B illustrates an evaluation of a next node in the rich trajectory. In FIG. 4B, more than one point on the sub-trajectory 422 is associated to a node 414 of the rich trajectory 408. More specifically, the node points 418 and 420 of the sub-trajectory 422 are included in the node points 412 that are associated with the node 414 of the rich trajectory 408. In this example, the node point 418 and the node point 420 are both associated with the task 404. The node point 418 is also associated with the task 416 (zⱼ).

In this example, both of the node points 418 and 420 are assigned to or associated with the task 404. This demonstrates that the node 414 can be assigned or associated with the task 404 regardless of whether one or more node points are also assigned to another task, such as the node point 418, which is also associated with the task 416. More specifically, because all of the node points 412 are associated with the task 404, the node 414 in the typical trajectory 414 is assigned the task 404. In one example, the node 414 is only associated with tasks that are common to all of the node points 412. In another example, the node 414 may be associated with any task associated with any of the node points 412. Thus, the node 414 may also be associated with the task 416 in another embodiment.

FIG. 4C discusses the process of determining a task to assign to or associate to the node 428 in the rich trajectory 408. In this example, the node points 430 include a node point 426, which is associated with the task 404, and a node point 424, which is not assigned to the task 404. More specifically, the node point 424 is either not assigned to a task or assigned to a different task. Because all of the node points 430 are not assigned to a common task (e.g., the node point 424 in the sub-trajectory 422 and the node point 426 do not have a task in common), the node 428 in the rich trajectory 408 may not be assigned or associated with the task 404 in one example. In another example, the node 428 may be associated with any or all tasks associated with any of the node points 420. However, this example assumes that a task must be shared by all node points in order to be associated to a node of the rich trajectory.

FIGS. 4D and 4E illustrate two alternative methods for identifying task-bound trajectories. FIG. 4D discloses additional aspects of identifying task-bound rich trajectories and illustrates the task-bound trajectories after processing the trajectory 408 for two tasks. FIG. 4D illustrates a process where associating a task to a node in a rich trajectory requires all node points to have that task in common. In FIG. 4D, the node 432 is associated with the task 404 in the manner described previously in the rich trajectory 408. In addition, the methods previously described can be performed with each task associated to one or more points. As a result, the node 414 is associated with the 404 (zᵢ) in the typical trajectory 408. The node 428 is a gap in the rich trajectory 408 because the corresponding node points do not share a common task. Thus, the node 428 in the rich trajectory 408 is not assigned a task.

In this example of FIG. 4D, each sequence of nodes in the rich trajectory 408 that includes the same task results in a new task-bound rich trajectory. This example illustrates two sequences 434, and 438. The sequential nodes 406 and 414 form a task-bound rich trajectory 434 as they share the same task 404 (zᵢ). The node 432 is also a task-bound rich trajectory as it is associated with the task 404.

In this example, the node 428 is not associated with a task or is unassigned. This may result in a gap in the task-association. More specifically, because the node 428 is not associated to any tasks after processing the trajectory 408 for the tasks 404 and 416, the node 428 causes breaks in the task-bound rich trajectories. Thus, the trajectories 434 and 438 are two distinct task-bound rich trajectories. As discussed below, FIG. 4F illustrates that a gap may be allowed to resolve this issue and allow distinct task-bound trajectories to be combined. When allowed, the gap may be associated to the same task as the task-bound trajectories being effectively joined by the gap node 428.

Thus, nodes such as the node 428, which is not assigned to a task in this example, may be included in a task-bound rich trajectory. For example, if two task-bound trajectories (e.g., the trajectories 434 and 438) are separated by one node (e.g., the node 428) that node may be included in a larger task-bound rich trajectory.

FIG. 4E discloses additional aspects of identifying task-bound rich trajectories and illustrates the task-bound trajectories after processing the trajectory 450 for two tasks. The rich trajectory 450 is distinct from the rich trajectory 408 due to the manner in which tasks were assigned to or associated with the nodes of the rich trajectory 450 compared to the rich trajectory 408. In FIG. 4E, the node 414 is associated with the task 416 in addition to the task 404 because at least one of the node points corresponding to the node 414 included or was associated with the task 416. In FIG. 4E, the node 432 is associated with the task 404 in the manner described previously in the rich trajectory 408. In this example, the node 428 is associated to the task 404 because at least one of the node points 430 included the task 404.

The task-bound trajectories may be determined from the rich trajectory 450 in FIG. 4E as previously described with respect to the rich trajectory 408. This would result in two task-bound rich trajectories. A task-bound rich trajectory for the task 404 would include the nodes 406, 414, 428, and 432. A task-bound rich trajectory for the task 416 would include the node 414 in this example.

FIG. 4F illustrates an example of an allowed gap in a task-bound rich trajectory. FIG. 4F illustrates a task-bound rich trajectory 440 that includes a gap node corresponding to the node 428. In this example, the node 428 in the task-bound rich trajectory 440 is assigned or associated to the task 404. The task-bound rich trajectory 436 including the node 414 (and associated to task 416) remains unchanged.

Allowing gaps may reduce the number of task-bound trajectories. All nodes in the task-bound rich trajectory are associated with the same task. FIGS. 4D and 4F illustrate a reduction in the number of task-bound rich trajectories derived from the rich trajectory 408, and illustrates that nodes that are unassigned may be assigned to a task if the nodes qualify as a gap node. The rich trajectory of FIG. 4E does not have a gap node.

The example set forth in FIGS. 4A-4F uses a small number of nodes for clarity and to illustrate the process of generating task-bound rich trajectories or task-bound typical trajectories. However, some of the task-bound rich trajectories may be discarded if they are too small. Thus, single node trajectories would likely be discarded as they are not really sequences and are not truly representative of typical trajectories. Task-bound rich trajectories that do not contribute meaningfully to determine the importance of attributes with respect to the tasks being performed may be discarded.

In other example, tasks may be assigned to nodes or rich trajectories only when a majority of the node points have a common task.

FIGS. 4A-4E illustrate the construction of a table or database of task-bound rich trajectories [symbol] ((e.g., 316) that is generated from the rich trajectories table or database [symbol] (e.g., 302).

In one example, the database 316 of task-bound rich trajectories may be used to determine the attribute importance for similarity of trajectories belonging to the same class. In one example, a machine learning model (e.g., a classifier) is trained, in a supervised learning manner in one example, to determine the task based on the rich trajectory input. The feature importance is then determines using a suitable approach.

In summary, with reference to FIGS. 4A-4E, a rich trajectory 408 is evaluated for the purpose of identifying task-bound rich trajectories. For each node (e.g., the nodes 406, 414, 428, and 432), the tasks associated the corresponding sub-trajectory node points are checked. If the subj-trajectory node points have a task in common, then the node of the rich trajectory is assigned that task. Thus, because the node points 402 in FIG. 4A all share the same task 404, the node 406 of the rich trajectory is associated to the same task 404.

A similar process is illustrated for the node 414 in FIG. 4B. For similar reasons, the task 404 is associated to the node 414 as all of the node points 412 share the same common task 404.

A similar process is illustrated for the node 428 in FIG. 4C. However, one of the node points 430 is not associated with the task 404. As a result, the task 404 is not associated to the node 428 of the rich trajectory 408. FIG. 4D illustrates that the node 432 was associated to the task 404 in a similar manner.

Next, the same process is performed for the task 416 (zⱼ). As illustrated in FIG. 4A, none of the node points 402 are associated to the task 416. As a result, the task 416 is not associated to the node 406 of the rich trajectory. The process is repeated for all nodes in the rich trajectory 408. The final result of this process, shown in FIG. 4D, illustrates that the nodes 406, 414, and 432 are associated with the task and that the node 414 is also associated with the task 416.

The task-bound trajectories can be identified based on sequences of nodes in the rich trajectory 408 that share the same task as previously described.

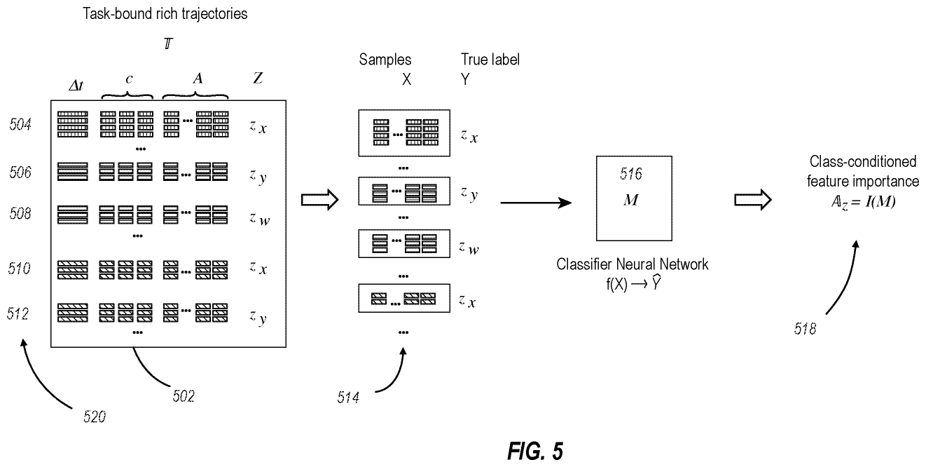

FIG. 5 discloses aspects of determining feature or attribute importance for task-bound rich trajectories. FIG. 5 illustrates, in this example a table or database 502 of collections or data that represents or defines task-bound rich trajectories. The table 500 includes collections 520 that represent task bound rich trajectories (e.g., trajectories 504, 506, 508, 510, and 512). Samples 514 (X) from the collections 520 are selected and are associated with their true labels (Y), which includes the task z for each of the trajectories represented in the samples 514. The samples 514 are used to train the classifier 516. The feature importance 518 (e.g., I(M)) of the fitted network is used as a stand in for the attribute importances [symbol] _{z} for the task-bound rich trajectories of each task z.

In one example, the samples 514 includes task-bound rich trajectories from the table 502. The number of nodes in the task-bound rich trajectories may vary. In one example, the number of attributes A in each node of each rich trajectory is known and fixed. However, because the number of nodes may vary, the classifier 516 may be capable of receiving a variable size input. Alternatively, the task-bound rich trajectories are processed into fixed-size partial rich trajectories. Fixed size partial rich trajectories can increase the number of samples (e.g., 2 nodes per sample).

In either case, the attributes of the nodes are input to the classifier 516. A feature importance approach (e.g., I) may be used and may depend on the data characteristics, the neural network model used as the classifier, or the like.

However, the feature importances correspond to attribute importances because the node attributes are the features of the classifier 516. As a result, the feature or attribute importances allows different tasks to be distinguished. Thus, different features or attributes may be important for different tasks.

Thus, in order to identify similar trajectories that accounts for context such as task, the feature importances may be used. For each task class z ∈ Z, the feature importances, an array of weights [symbol] _{z} are used for determining or computing similar trajectories.

In one example, embodiments of the invention may track multiple mobile devices operating in a domain or environment. For every mobile entity E, position corrdinates p and attributes Q are obtained (in real time or near real time). These data may be obtained from sensor data.

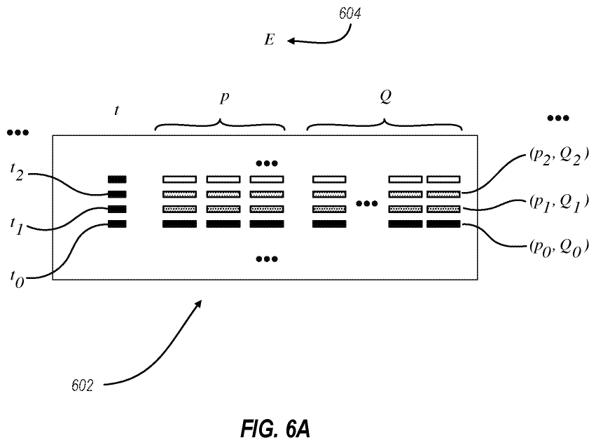

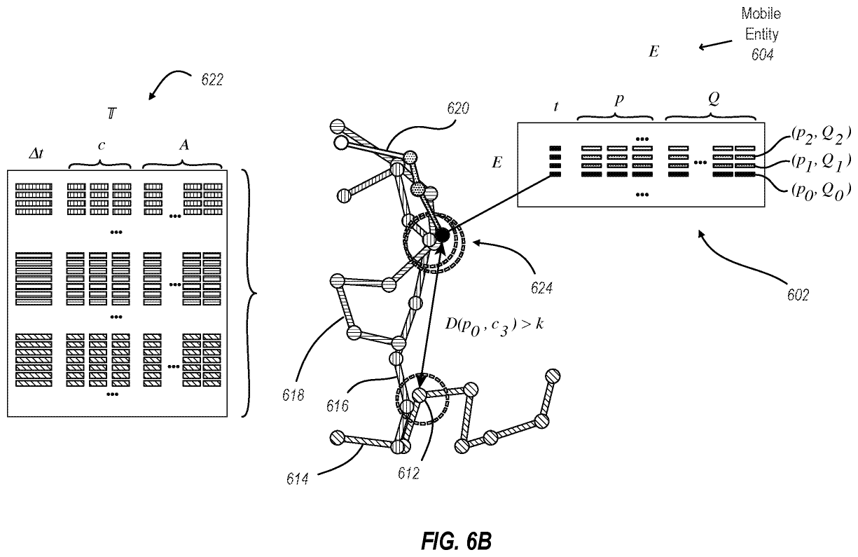

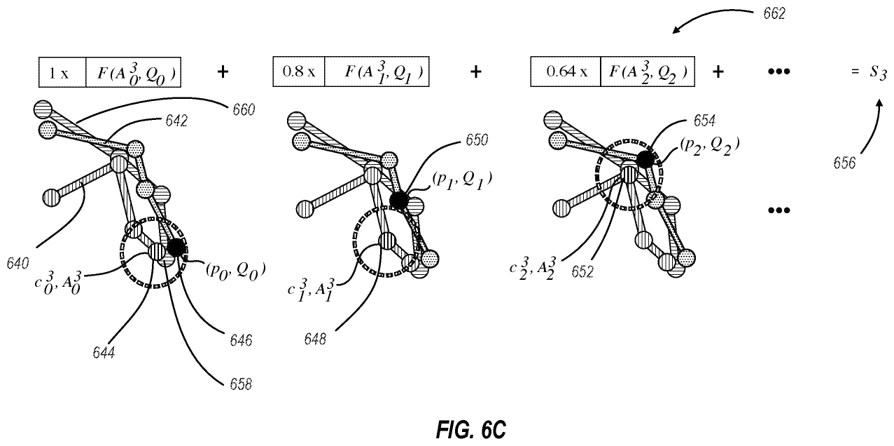

FIG. 6A discloses aspects of data collected from a mobile device. FIG. 6A illustrates collections 602 (which includes multiple individual collections) of data for mobile device 604 (or node operating in the domain). Each entry in the collections 602, which may be maintained at the device or at a central server, may include a timestamp t, position data p, and attributes Q. If the mobile device is an automated forklift or other automated robot (or an operated device), the attributes may include loaded/unloaded, load weight, mast height, or the like. Sensors may also track inertial data, direction of travel, velocity, or the like. The most recent collection may be labeled (p₀, Q₀).

Next, a trajectory filtering is performed to find rich trajectories that are similar in terms of path or positions. In this example, finding rich trajectories that are similar in path is based on the positioning coordinates c of the mobile entity's current path and the position data included in the nodes of the rich trajectories.

FIG. 6B discloses aspects of identifying similar rich trajectories. FIG. 6B illustrates collections 602 of data (e.g., timestamp, position, attributes) for a mobile entity 604. The collections 602 correspond to a current path (or trajectory) 620 of the mobile entity 604. The paths or trajectories 612, 614, 616, and 618 are available in the rich trajectories 622. In this example, similar trajectories are identified based on path or trajectory. The node points 624 represent a current position of the entity 604 and node points of other trajectories, including the trajectories 616 and 618. The node points 624 are identified using a distance measurement. For example, all trajectories with a node or node point within a predetermined distance may be considered as a candidate trajectory.

The trajectory 614 is not considered a candidate trajectory because its closest node point 612 at position C₃ to the current position poof the entity 604 is larger than a threshold k.

In other words,

$$D ( {p}_{0} , {c}_{3} ) > k .$$

Trajectories having nodes that whose distance is equal to or less than k may be candidate trajectories.

A similarity scoring process is performed to determine or identify the rich trajectory that is consistently most similar to the current trajectory 620 of the mobile entity 604. Preference may be given to the rich trajectory that is most similar in the most recent positions.

FIG. 6C discloses aspects of determining a similarity score between a current trajectory and candidate trajectories. FIG. 6C illustrates a current trajectory 642 and nodes 646, 650, and 654. Because the nodes 644 of the rich trajectory 640 and the node 658 of the rich trajectory 660 satisfy the nearness distance requirement, the rich trajectories 640 and 660 are candidate nodes. To determine the similarity of the trajectory 640 to the current trajectory 642, nodes of the trajectory 640 are matched to the nodes of the path 642 and compared. A similarity function F, which may use the attributes of the respective nodes and/or position, is determined for each of the nodes in the two trajectories.

In this example, the contributions from each node comparison (node 644 and node 646, node 648 and node 650, and node 652 and node 654) are weighted based on recency as illustrated in the equation 662. The similarity score 656 is generated, in this example, as a sum, with contributing terms from each node. The trajectory with the best similarity score is determined to be the most similar trajectory to the current trajectory 642. If the trajectory 640 is the most similar trajectory, the trajectory 640 may also be the forecasted trajectory for the mobile entity.

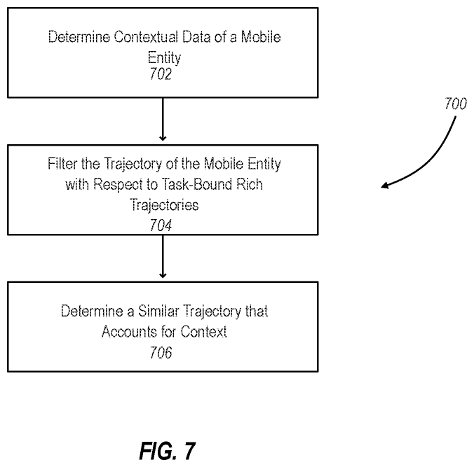

FIG. 7 discloses aspects of determining a context aware trajectory that is most similar to a current trajectory. The method 700 includes determining 702 a task (or context) of a mobile entity. For example, this may include determining a task z being performed by the mobile entity. If the task z is available, embodiments filter 704 the current trajectory of the mobile entity with a database or table of task-bound rich trajectories (e.g., [symbol] 316). Because the task or context is known, the search for similar trajectories in the trajectory database 316 is constrained to trajectories having the same task. If the task is unknown, the trajectory may be filtered against the table or database of typical rich trajectories (e.g., [symbol] 302).

Next, a similar trajectory is determined 706 from the candidate task-bound rich trajectories by computing a similarity score. Thus, the search for a similar task-bound rich trajectory accounts for context or task. More specifically, the attribute importances [symbol] _{z} are used for the similarity scoring function F (A, Q). However, the element-wise absolute differences are determined as follows and account for context or task:

$$F ( A , Q , z ) = \frac{1}{\vert A \vert} {\sum }_{n = 0}^{\vert A \vert} {z}_{} [ n ] \times \vert A [ n ] - Q [ n ] \vert .$$

As a result, embodiments of the invention determine context-aware forecasting of a current trajectory. By identifying the most similar trajectory, in a context aware manner, the likely or potential trajectory of a mobile entity or device can be estimated or forecast.

Embodiments of the invention may also be configured to monitor the behavior of mobile entities by leveraging the structure [symbol] and their known current tasks. For example, a similarity score of a current trajectory of a mobile device, performing a particular task, is computed with respect to trajectories of other tasks. If a historical rich trajectory bound to a task w≠z is observed to have a significantly higher similarity to the current trajectory than any rich trajectories of task z, the current trajectory may be flagged for review.

The flagged trajectories may be, over time, collected and analyzed (typically by domain experts) to determine applicable rectifications. They may indicate nonconformant behavior, or that the set of tasks Z defined in the domain has overlapping meaning (i.e., tasks z and w may be similar or even partially the same task).

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, trajectory related operations, trajectory similarity operations, trajectory forecasting operations, context-aware trajectory operations, or the like. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data storage functionality for one or more clients. Another example of a cloud computing environment is one in which processing, data storage, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

As used herein, the term ‘data’ is intended to be broad in scope. Example embodiments of the invention are applicable to any system capable of storing and handling various types of objects or data, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: determining a context of a mobile entity operating in a domain, filtering a database of task-bound trajectories, wherein the filtering is constrained by the context, to identify candidate trajectories that are each associated with the same context as the mobile entity, determining a similar trajectory from the candidate trajectories, wherein a similarity score for each of the candidate trajectories accounts for attribute importances, wherein the similar trajectory has a highest similarity score, wherein the similar trajectory is considered as an expected trajectory for the mobile entity.

Embodiment 2. The method of embodiment 1, wherein the context of the mobile entity comprises a current task being performed by the mobile entity.

Embodiment 3. The method of embodiment 1 and/or 2, further comprising generating the database of task-bound trajectories from a database of rich trajectories, wherein the database of rich trajectories are based on positions of multiple mobile entities operating in the domain.

Embodiment 4. The method of embodiment 1, 2, and/or 3, further comprising associating nodes of each of the rich trajectories with at least one context, wherein the at least one context comprises a task.

Embodiment 5. The method of embodiment 1, 2, 3, and/or 4, wherein the at least one context of each of the rich trajectories is determined from associated sub-trajectories.

Embodiment 6. The method of embodiment 1, 2, 3, 4, and/or 5, further comprising generating the rich trajectories from a database of collections corresponding to the sub-trajectories.

Embodiment 7. The method of embodiment 1, 2, 3, 4, 5, and/or 6, further comprising training a model using a sample of the task-bound trajectories, wherein an input to the model comprises attributes associated with the samples.

Embodiment 8. The method of embodiment 1, 2, 3, 4, 5, 6, and/or 7, further comprising determining feature importances for the task bound trajectories.

Embodiment 9. The method of embodiment 1, 2, 3, 4, 5, 6, 7, and/or 8, wherein the feature importances correspond to attribute importances, wherein the similarity scores are based on the attribute importances.

Embodiment 10. The method of embodiment 1, 2, 3, 4, 5, 6, 7, 8, and/or 9, further comprising monitoring behaviors of mobile entities by comparing similarity scores for current tasks with similarity scores associated with non-similar tasks but similar paths and flagging high scoring trajectories. rectifying the task-bound trajectories based on the similarity scores for the non-similar tasks.

Embodiment 11 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

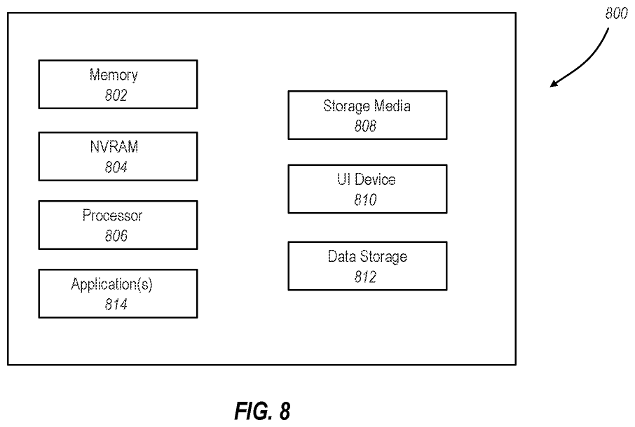

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 802.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining a context of a mobile entity operating in a domain;
filtering a database of task-bound trajectories, wherein the filtering is constrained by the context, to identify candidate trajectories that are each associated with the same context as the mobile entity;
determining a similar trajectory from the candidate trajectories, wherein a similarity score for each of the candidate trajectories accounts for attribute importances, wherein the similar trajectory has a highest similarity score, wherein the similar trajectory is considered as an expected trajectory for the mobile entity.

2. The method of claim 1, wherein the context of the mobile entity comprises a current task being performed by the mobile entity.

3. The method of claim 2, further comprising generating the database of task-bound trajectories from a database of rich trajectories, wherein the database of rich trajectories are based on positions of multiple mobile entities operating in the domain.

4. The method of claim 3, further comprising associating nodes of each of the rich trajectories with at least one context, wherein the at least one context comprises a task.

5. The method of claim 4, wherein the at least one context of each of the rich trajectories is determined from associated sub-trajectories.

6. The method of claim 5, further comprising generating the rich trajectories from a database of collections corresponding to the sub-trajectories.

7. The method of claim 1, further comprising training a model using a sample of the task-bound trajectories, wherein an input to the model comprises attributes associated with the samples.

8. The method of claim 6, further comprising determining feature importances for the task bound trajectories.

9. The method of claim 7, wherein the feature importances correspond to attribute importances, wherein the similarity scores are based on the attribute importances.

10. The method of claim 1, further comprising monitoring behaviors of mobile entities by comparing similarity scores for current tasks with similarity scores associated with non-similar tasks but similar paths and flagging high scoring trajectories. rectifying the task-bound trajectories based on the similarity scores for the non-similar tasks.

11. A non-transitory storage medium having stored therein instructions that are executable by one or more hardware processors to perform operations comprising:
determining a context of a mobile entity operating in a domain;
filtering a database of task-bound trajectories, wherein the filtering is constrained by the context, to identify candidate trajectories that are each associated with the same context as the mobile entity;
determining a similar trajectory from the candidate trajectories, wherein a similarity score for each of the candidate trajectories accounts for attribute importances, wherein the similar trajectory has a highest similarity score, wherein the similar trajectory is considered as an expected trajectory for the mobile entity.

12. The non-transitory storage medium of claim 11, wherein the context of the mobile entity comprises a current task being performed by the mobile entity.

13. The non-transitory storage medium of claim 12, further comprising generating the database of task-bound trajectories from a database of rich trajectories, wherein the database of rich trajectories are based on positions of multiple mobile entities operating in the domain.

14. The non-transitory storage medium of claim 13, further comprising associating nodes of each of the rich trajectories with at least one context, wherein the at least one context comprises a task.

15. The non-transitory storage medium of claim 14, wherein the at least one context of each of the rich trajectories is determined from associated sub-trajectories.

16. The non-transitory storage medium of claim 15, further comprising generating the rich trajectories from a database of collections corresponding to the sub-trajectories.

17. The non-transitory storage medium of claim 11, further comprising training a model using a sample of the task-bound trajectories, wherein an input to the model comprises attributes associated with the samples.

18. The non-transitory storage medium of claim 16, further comprising determining feature importances for the task bound trajectories.

19. The non-transitory storage medium of claim 17, wherein the feature importances correspond to attribute importances, wherein the similarity scores are based on the attribute importances.

20. The non-transitory storage medium of claim 11, further comprising monitoring behaviors of mobile entities by comparing similarity scores for current tasks with similarity scores associated with non-similar tasks but similar paths and flagging high scoring trajectories. rectifying the task-bound trajectories based on the similarity scores for the non-similar tasks.
